(19) United States
(12) Patent Application Publication
(10) Pub. No.: US 2008/0115680 A1
(43) Pub. Date: May 22, 2008

(54) PRINTER-ROLLER SUPPORT STRUCTURE AND PRINTER

(75) Inventors: Fumito Kajitani, Hiroshima-Ken (JP); Shigeo Makino, Hiroshima-Ken (JP); Yukikazu Shoji, Hiroshima-Ken (JP); Yoshiaki Kanda, Hiroshima-Ken (JP); Yasunori Tanabe, Hiroshima-Ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/942,581

(22) Filed: Nov. 19, 2007

(30) Foreign Application Priority Data
Nov. 20, 2006 (JP) 2006-313417

(51) Int. Cl. B41F 1/46

(52) U.S. Cl. 101/348

(57) ABSTRACT

An ink-transfer roller is brought into contact with an ink-source roller so that ink is transferred from the ink-source roller to the ink-transfer roller. The ink-transfer roller includes an ink-transfer member, an ink-transfer roller body, an elastic member, and a rotation axis. The elastic member is provided between the rotation axis and the ink-transfer roller body.

### BACKGROUND OF THE INVENTION

1. Field of the Invention

The present invention relates to a technology for supporting rollers that constitute an ink-supply path of a printer.

2. Description of the Related Art

In a printer, ink supplied from an ink-supply source passes through an ink-supply path formed of a plurality of rollers until an image is printed on a recording medium (recording sheet). Japanese Patent Application Laid-open No. H1-93397 (p. 3, and FIGS. 1 and 2) discloses a conventional technology in which a source roller draws up ink from an ink reservoir to form an ink coating on the surface thereof. An ink-transfer roller delivers the ink from the source roller. The ink-transfer roller includes a core and a base material layer such as rubber formed on the core. A plurality of spherical depressions is formed on the surface of the base material layer, and a plurality of hollow microspheres is formed therein.

In the conventional technology, the source roller that draws up the ink from the ink reservoir is brought into contact with the ink-transfer roller to supply the ink to the ink-transfer roller. In this case, frictional heat is generated between the source roller and the ink-transfer roller due to a circumferential speed difference therebetween, and the source roller and the ink-transfer roller expand due to the frictional heat.

As a result, the pressure in the contact area between the source roller and the ink-transfer roller changes, and the film thickness of the ink formed on the surface of the ink-transfer roller changes or poor transfer of the ink to the ink-transfer roller occurs. Consequently, the ink cannot be supplied stably. This problem not only occurs in the relation between the source roller and the ink-transfer roller, but also may occur in at least a pair of rollers, among rollers constituting the ink-supply path, which come in contact with each other. If such poor ink supply occurs in any one point of the ink-supply path, printing quality degrades.

### SUMMARY OF THE INVENTION

It is an object of the present invention to at least partially solve the problems in the conventional technology.

According to an aspect of the present invention, a printer-roller support structure for a printer including a plurality of rollers that constitutes an ink-supply path, includes an elastic member that is located between a supporting member that supports a rotation axis of at least one of a pair of rollers in the ink-supply path and a contact area of the pair of rollers.

According to another aspect of the present invention, a printer-roller support structure for a printer including a plurality of rollers that constitutes an ink-supply path, includes an elastic member that is located between a bearing that supports a rotation axis of at least one of a pair of rollers in the ink-supply path and the rotation axis.

According to still another aspect of the present invention, a printer-roller support structure for a printer including a plurality of rollers that constitutes an ink-supply path, includes an elastic member that is located between a bearing that supports a rotation axis of at least one of a pair of rollers in the ink-supply path and a supporting member that supports the bearing.

According to still another aspect of the present invention, a printer-roller support structure for a printer including a plurality of rollers that constitutes an ink-supply path, includes a pressurizing member that is located between a rotation axis of at least one of a pair of rollers in the ink-supply path and a supporting member that supports the rotation axis, and pressurizes the rotation axis.

According to still another aspect of the present invention, a printer includes a plurality of rollers that constitutes an ink-supply path extending from an ink-supply source to a recording medium; a supporting member that supports a rotation axis of at least one of a pair of rollers in the ink-supply path; and a printer-roller support structure that supports at least the pair of rollers, and include an elastic member that is located between the supporting member and a contact area of the pair of rollers.

According to still another aspect of the present invention, a printer includes a plurality of rollers that constitutes an ink-supply path extending from an ink-supply source to a recording medium; a bearing that supports a rotation axis of at least one of a pair of rollers in the ink-supply path; and a printer-roller support structure that supports at least the pair of rollers, and include an elastic member that is located between the bearing and the rotation axis.

According to still another aspect of the present invention, a printer includes a plurality of rollers that constitutes an ink-supply path extending from an ink-supply source to a recording medium; a bearing that supports a rotation axis of at least one of a pair of rollers in the ink-supply path; a supporting member that supports the bearing; and a printer-roller support structure that supports at least the pair of rollers, and include an elastic member that is located between the bearing and the supporting member.

According to still another aspect of the present invention, a printer includes a plurality of rollers that constitutes an ink-supply path extending from an ink-supply source to a recording medium; a supporting member that supports a rotation axis of at least one of a pair of rollers in the ink-supply path; and a printer-roller support structure that supports at least the pair of rollers, and include a pressurizing member that is located between the rotation axis and the supporting member and pressurizes the rotation axis.

The above and other objects, features, advantages and technical and industrial significance of this invention will be better understood by reading the following detailed description of presently preferred embodiments of the inventions when considered in connection with the accompanying drawings.

### BRIEF DESCRIPTION OF THE DRAWINGS

FIG. 1 is a schematic diagram of a printing system including a printer having a printer-roller support structure according to an embodiment of the present invention;

FIG. 2 is a schematic diagram of the printer;

FIG. 3 is a plan view of a pair of rollers one of which is supported by the printer-roller support structure;

FIG. 4A is a schematic diagram of an ink-transfer roller shown in FIG. 2;

FIG. 4B is a schematic diagram of the printer-roller support structure in operation;

FIG. 5A is a cross section of a bearing used for a printer-roller support structure according to a first modification of the embodiment;

FIG. 5B is a cross section of another type of bearing used for the printer-roller support structure according to the first modification;

FIG. 6 is a plan view of a pair of rollers one of which is supported by the printer-roller support structure according to the first modification; and

FIG. 7 is a plan view of a pair of rollers one of which is supported by a printer-roller support structure according to a second modification of the embodiment.

### DETAILED DESCRIPTION OF THE PREFERRED EMBODIMENTS

Exemplary embodiments of the present invention are explained in detail below with reference to the accompanying drawings. Note that the present invention is applicable to any other printing than offset printing regardless of the type of ink to be used.

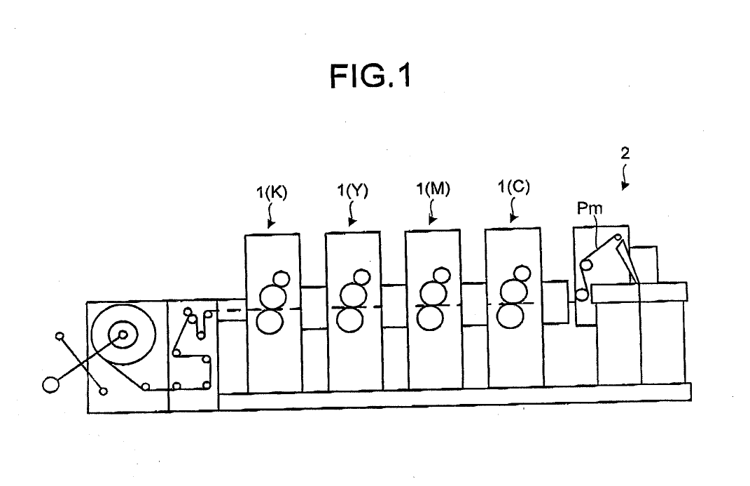

FIG. 1 is a schematic diagram of a printing system 2 including a printer 1 (printers 1(Y), 1(M), 1(C), and 1(K)) according to an embodiment of the present invention. The printer 1 has a printer-roller support structure, and is explained as an offset printer in which an image formed by applying ink to an image area on a plate is transferred onto a recording medium via a blanket.

As described above, the printing system 2 includes the printers 1(Y), 1(M), 1(C), and 1(K) for four colors of yellow (Y), magenta (M), cyan (C), and black (K) generally used in printing. The printer 1 prints an image on a surface of a recording medium (hereinafter, “sheet”) Pm. The printer 1 includes a printing unit to print an image on one side of the sheet Pm. The printer 1 can include a plurality of printing units to print an image on both sides of the sheet Pm for duplex printing.

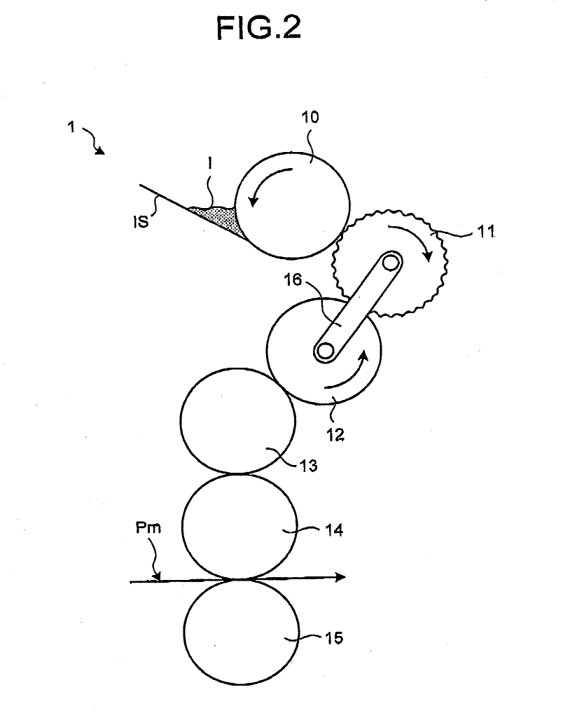

A configuration of the printer 1 is explained in detail referring to FIG. 2. The printer 1 includes an ink storage IS, an ink-source roller 10, an ink-transfer roller 11, an inking roller 12, a plate roller 13, and a blanket roller 14. The inking roller 12 is made of rubber (e.g., nitrile rubber: NBR). A rubber blanket is fitted to the blanket roller 14. The configuration of the printer 1 is not limited to the one shown in FIG. 2, and the printer 1 can include other rollers as required.

The plurality of rollers (e.g., the ink-source roller 10 and the inking roller 12) constitutes an ink-supply path, through which ink from an ink reservoir (the ink storage IS) travels until it is transferred onto a recording medium. A member (e.g., an elastic member or an air cylinder) is provided between a supporting member that supports the rotation axis of at least one of a pair of rollers in the ink-supply path and the contact area of the pair of rollers to maintain pressure in the contact area at a predetermined value.

Ink I is supplied from the ink storage IS to the ink-source roller 10, and then is supplied to the ink-transfer roller 11 that cores in contact with the ink-source roller 10. The ink-transfer roller 11 is supported by a support arm 16. A roller having a microfabricated surface (e.g., an anilox roller) is used as the ink-transfer roller 11. Apart from an anilox roller, examples of the ink-transfer roller 11 include, but are not limited to, a rubber roller, and a roller having pores on the surface thereof. The ink I can be supplied to the ink-transfer roller 11 by spraying it onto the ink-transfer roller 11 with a spray or the like.

The ink-transfer roller 11 comes in contact with the inking roller 12, and the ink I on the surface of the ink-transfer roller 11 is transferred onto the inking roller 12. The inking roller 12 comes in contact with the plate roller 13, and the ink I on the surface of the inking roller 12 is transferred onto an image area on a plate (flat plate) fitted to the plate roller 13. On the plate, the ink I forms an image to be printed on the sheet Pm. The sheet Pm is pressed to the blanket roller 14 by a backup roller 15, so that the image on the plate is transferred onto the blanket fitted to the blanket roller 14 and is then transferred onto the sheet Pm. The printer-roller support structure is explained next.

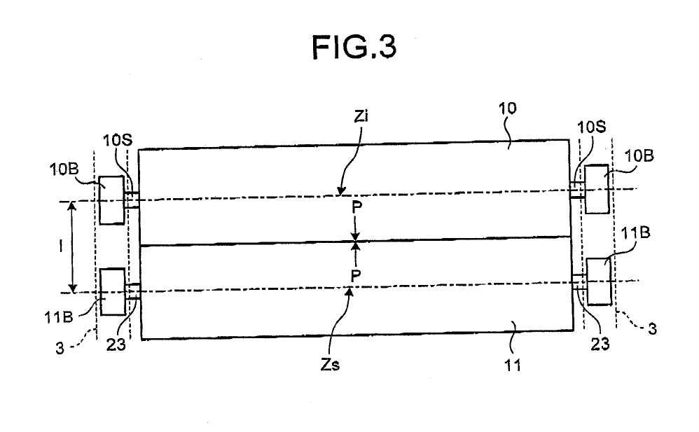

FIG. 3 is a plan view of a pair of the rollers 10 and 11 one of which is supported by the printer-roller support structure. The printer-roller support structure suppresses a change in ink transfer state between rollers due to a change in roller diameter (thermal expansion) by heat generated from friction between the rollers. Accordingly, the printer-roller support structure can be applied to a part where such a problem occurs.

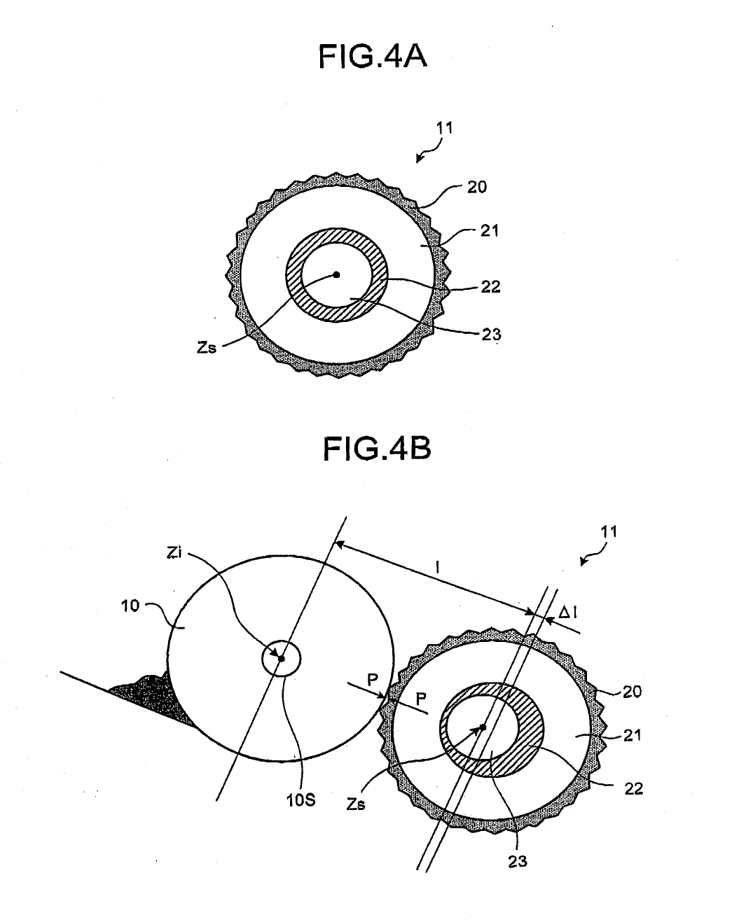

An example in which the ink-transfer roller 11 is supported by the printer-roller support structure between the ink-source roller 10 and the ink-transfer roller 11 is explained next. FIG. 4A is a schematic diagram of the ink-transfer roller 11. The ink-transfer roller 11 includes an ink-transfer member 20, an ink-transfer roller body 21, an elastic member 22, and a rotation axis 23. The ink transfer member 20 has a cylindrical structure with a microfabricated surface, which is detachably attached to an outer circumference of the cylindrical ink-transfer roller body 21. When worn out, the ink-transfer member 20 can be taken off from the cylindrical ink-transfer roller body 21 and replaced by a new one, which is advantageous in the economical aspect. The ink-transfer member 20 can also be integrally formed with the ink-transfer roller body 21.

FIG. 4B is a schematic diagram of the printer-roller support structure in operations. As shown in FIG. 4, an ink-source roller rotation axis 10S is supported by an ink-source roller bearing 10B (see FIG. 3) so that the ink-source roller 10 can rotate about a central axis Z1. The rotation axis 23 is supported by an ink-transfer roller bearing 11B (see FIG. 3) so that the ink-transfer roller 11 can rotate about a central axis Zs. As shown in FIG. 3, the ink-source roller bearing 10B and the ink-transfer roller bearing 11B are supported by a frame 3 as a supporting member. Accordingly, the ink-source roller 10 and the ink-transfer roller 11 are supported by the frame 3. As shown in FIGS. 3 and 4B, a distance of between the central axis Z1 and the central axis Zs (hereinafter, “inter-axis distance”) is represented by 1.

The elastic member 22 is arranged between the rotation axis 23 and the ink-transfer roller body 21. The ink-transfer member 20 and the ink-transfer roller body 21 are supported by the rotation axis 23 via the elastic member 22. That is, the elastic member 22 is arranged between the frame 3 and a contact area between the ink-source roller 10 and the ink-transfer roller 11. The elastic member 22 is made of an elastic material. When the inter-axis distance 1 changes, the elastic member 22 deforms to absorb the change in the inter-axis distance 1, thereby maintaining pressure P constant in the contact area between the ink-source roller 10 and the ink-transfer roller 11.

The ink-source roller 10 and the ink-transfer roller 11 come in contact with each other and rotate while the printer 1 is in operation. Because of a peripheral speed difference therebetween, frictional heat is generated in the contact area therebetween. Accordingly, the ink-source roller 10 and the ink-transfer roller 11 thermally expand in a radial direction. The thermal expansion corresponds to a change by an amount Δ1 in the inter-axis distance 1 as shown in FIG. 4B. Because the inter-axis distance 1 should be constant, when the inter-axis distance 1 changes by Δ1, the pressure P in the contact area between the ink-source roller 10 and the ink-transfer roller 11 increases. Consequently, the thickness of an ink film changes or supply of the ink I is interrupted, resulting in unstable supply of the ink I.

In the printer-roller support structure, the elastic member 22 is arranged between the ink-transfer roller body 21 and the rotation axis 23. Therefore, as shown in FIG. 4B, even when the inter-axis distance 1 changes by Δ1 due to thermal deformation caused by heat generated at the ink-source roller 10 or the ink-transfer roller 11, the elastic member 22 deforms in the direction in which the inter-axis distance 1 changes by Δ1 to absorb the change of the inter-axis distance 1. Accordingly, while the inter-axis distance 1 is maintained constant, the pressure P in the contact area between the ink-source roller 10 and the ink-transfer roller 11 is maintained substantially constant to suppress an increase in the pressure P. As a result, the thickness of an ink film can be maintained constant, and interruption of ink supply can be avoided, which enables stable supply of the ink. Further, by replacing the elastic member 22 by a member having different compressibility with respect to the ink having different appropriate contact pressure, an appropriate contact pressure can be generated between different types of ink. The elastic member 22 can be arranged between the ink-transfer member 20 and the ink-transfer roller body 21.

For example, rubber, elastomer, or a resin material can be used for the elastic member 22. As examples of such material can be cited NBR and urethane. When a rubber material is used for the elastic member 22, it is desired that the elastic member 22 have a rubber hardness Hs in a range of 25 degrees to 50 degrees. Accordingly, the change of the inter-axis distance is absorbed while the ink-transfer roller 11 is supported, which reliably makes pressure constant in the contact area of rollers. The rubber hardness is determined by vulcanized or thermoplastic rubber hardness test according to Japanese Industrial Standard (JIS) K 6253.

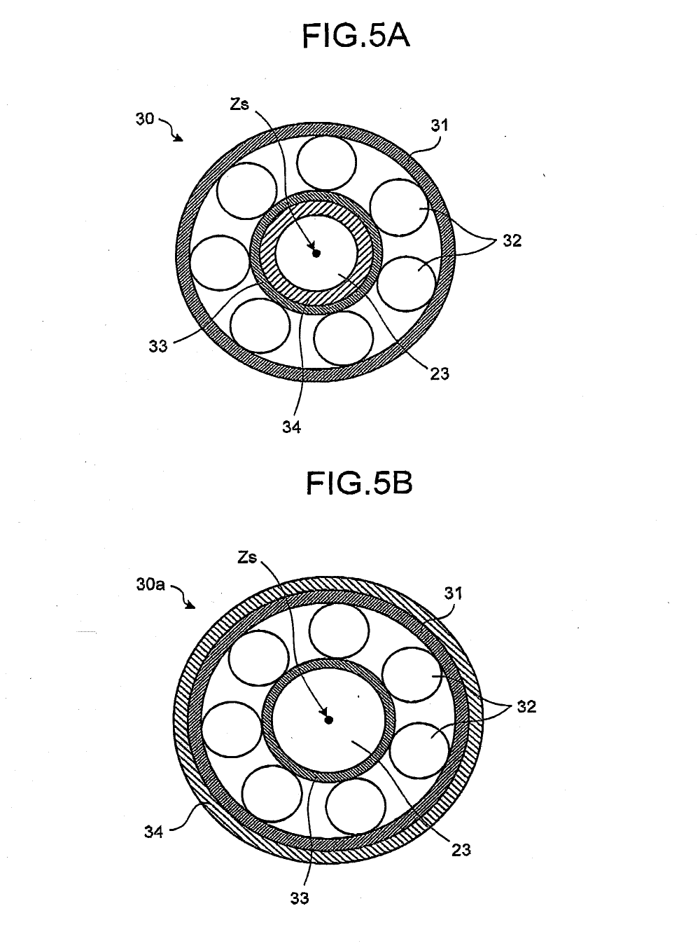

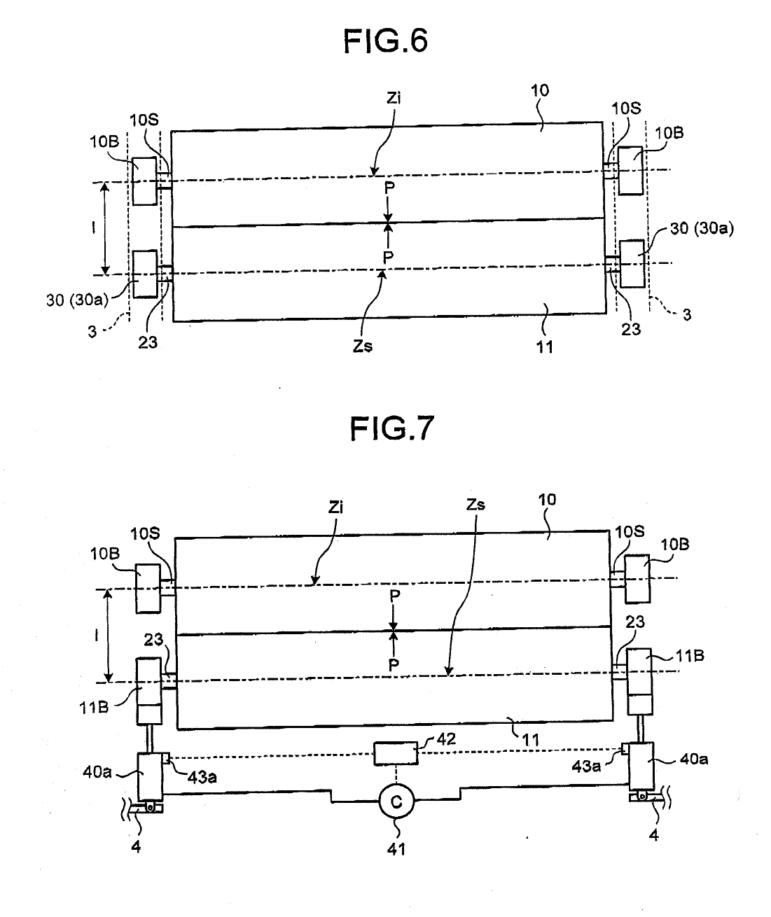

FIGS. 5A and 5B are cross sections of different types of bearings used for the printer-roller support structure according to a first modification of the embodiment. FIG. 6 is a plan view of a pair of the rollers 10 and 11 one of which is supported by the printer-roller support structure according to the first modification. In the printer-roller support structure according to the embodiment, the elastic member 22 capable of absorbing displacement is arranged between the rotation axis of the roller and the roller body (specifically, between the ink-transfer roller body 21 of and the rotation axis 23 of the ink-transfer roller 11). In the first modification, an elastic member 34 is provided on a bearing that supports at least one of a pair of the rollers.

In the printer-roller support structure shown in FIG. 5A, the elastic member 34 is provided to an ink-transfer roller bearing 30 that rotatably supports the rotation axis 23 of the ink-transfer roller 11. As shown in FIG. 6, the ink-transfer roller bearing 30 is supported by the frame 3. The ink-transfer roller bearing 30 is a so-called ball bearing having a plurality of steel balls 32 arranged, for example, between a toroidal outer frame 31 and a toroidal inner frame 33 inside the outer frame 31. Cylindrical rollers, conical rollers, or the like can be used in place of the steel balls 32. An elastic member 34 is provided inside the inner frame 33 to support the rotation axis 23 via the elastic member 34. Consequently, the rotation axis 23 is rotatably supported on the central axis Zs of rotation of the ink-transfer roller 11. That is, in the printer-roller support structure shown in FIG. 5A, the elastic member 34 is provided between the ink-transfer roller bearing 30 and the rotation axis 23.

An ink-transfer roller bearing 30a shown in FIG. 5B is basically similar to the ink-transfer roller bearing 30 shown in FIG. 5A except that the elastic member 34 is provided on the outer surface of the outer frame 31. As shown in FIG. 6, the ink-transfer roller bearing 30 is supported by the frame 3. That is, in the printer-roller support structure shown in FIG. 5B, the elastic member 34 is provided between the ink-transfer roller bearing 30a and the frame 3.

When the inter-axis distance 1 changes, the elastic member 34 absorbs the change of the inter-axis distance 1 to maintain the pressure P substantially constant in the contact area between the ink-source roller 10 and the ink-transfer roller 11. Consequently, the thickness of an ink film can be maintained constant, and also interruption of ink supply can be avoided, which enables stable supply of ink. The elastic member 34 provided to the ink-transfer roller bearings 30 and 30a can be formed of the same material as that of the elastic member 22 (FIGS. 4A and 4B).

FIG. 7 is a plan view of a pair of the rollers 10 and 11 one of which is supported by a printer-roller support structure according to a second modification of the embodiment. In the second modification, a pressurizing member is provided on the rotation axis of at least one of a pair of the rollers, and pressure applied by the pressurizing member is adjusted to maintain pressure constant in the contact area of rollers. In the second modification, two air cylinders 40a are used as the pressurizing member. The air cylinders 40a pressurize both ends of the rotation axis 23 of the ink-transfer roller 11.

In the second modification, one end of each of the air cylinders 40a is fitted to a frame 4 that supports the rotation axis 23 via the ink-transfer roller bearing 11b, and the other end is fitted to the ink-transfer roller bearing 11B provided on both ends of the rotation axis 23. That is, the air cylinders 40a are provided between the frame 4 and the rotation axis 23. The air cylinders 40a pressurize both ends of the rotation axis 23 via the ink-transfer roller bearing 11B.

Pressure applied by the air cylinders 40a is generated by pressurized air supplied from a compressor 41 as a pressure-supply unit. Pressure generated by the compressor 41 is adjusted by a controller 42. The controller 42 obtains pressure in the air cylinders 40a by pressure sensors 43a fitted to the air cylinders 40a, respectively, and adjusts the pressure generated by the compressor 41 so that the pressure P is maintained constant in the contact area between the ink-source roller 10 and the ink-transfer roller 11. The pressure adjusted by the controller 42 is applied to the air cylinders 40a. That is, the controller 42 controls pressure to be applied to the air cylinders 40a to be maintained constant.

Because the pressure P can be maintained substantially constant in the contact area between the ink-source roller 10 and the ink-transfer roller 11, the thickness of an ink film can be maintained constant, and interruption of the ink supply can be avoided. This enables stable supply of ink. An appropriate contact pressure can be generated between different types of ink by changing the pressure in the respective air cylinders 40a for ink having a different appropriate contact pressure.

The support structure in which the elastic member 22 is provided between the ink-transfer member 20 and the ink-transfer roller body 21 as shown in FIG. 4A, and the ink-transfer roller bearing 30 (30a) including the elastic member 34 and the air cylinders 40a can be used together. With this configuration, the elastic members 22 and 34 can correct changes with the lapse of time by using the air cylinders 40a. Therefore, the pressure P can be maintained constant more easily and accurately in the contact area between the ink-source roller 10 and the ink-transfer roller 11.

In the embodiment and the modifications thereof, a member (e.g., the elastic member or the air cylinder) is provided between a supporting member that supports the rotation axis of at least one of a pair of rollers in an ink-supply path of the printer and the contact area of the rollers to maintain pressure in the contact area at a predetermined value. Accordingly, even when either or both the rollers are thermally expanded, the pressure can be maintained substantially constant in the contact area between the rollers before and after the thermal expansion. Thus, ink can be stably supplied to the ink-supply path. Besides, even if the amount of heat generated from friction between the rollers increases due to their high speed rotation, ink can also be stably supplied to the ink-supply path.

As set forth hereinabove, according to an embodiment of the present invention, even if rollers in an ink-supply path of a printer thermally expands during operation of the printer, an elastic member deforms to absorb thermal expansion of the rollers. Therefore, pressure can be maintained substantially constant in the contact area of the rollers before and after the thermal expansion. As a result, ink can be stably supplied to between rollers that constitute the ink-supply path.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printer-roller support structure for a printer including a plurality of rollers that constitutes an ink-supply path, the printer-roller support structure comprising:
an elastic member that is located between a supporting member that supports a rotation axis of at least one of a pair of rollers in the ink-supply path and a contact area of the pair of rollers.

2. The printer-roller support structure according to claim 1, wherein the one of the pair of rollers includes a roller body, and the elastic member between the roller body and the rotation axis.

3. A printer-roller support structure for a printer including a plurality of rollers that constitutes an ink-supply path, the printer-roller support structure comprising:
an elastic member that is located between a bearing that supports a rotation axis of at least one of a pair of rollers in the ink-supply path and the rotation axis.

4. A printer-roller support structure for a printer including a plurality of rollers that constitutes an ink-supply path, the printer-roller support structure comprising:
an elastic member that is located between a bearing that supports a rotation axis of at least one of a pair of rollers in the ink-supply path and a supporting member that supports the bearing.

5. A printer-roller support structure for a printer including a plurality of rollers that constitutes an ink-supply path, the printer-roller support structure comprising:
a pressurizing member that is located between a rotation axis of at least one of a pair of rollers in the ink-supply path and a supporting member that supports the rotation axis, and pressurizes the rotation axis.

6. A printer comprising:
a plurality of rollers that constitutes an ink-supply path extending from an ink-supply source to a recording medium; and
the printer-roller support structure according to claim 1 that supports at least a pair of rollers among the rollers.

7. A printer comprising:
a plurality of rollers that constitutes an ink-supply path extending from an ink-supply source to a recording medium; and
the printer-roller support structure according to claim 2 that supports at least a pair of rollers among the rollers.

8. A printer comprising:
a plurality of rollers that constitutes an ink-supply path extending from an ink-supply source to a recording medium; and
the printer-roller support structure according to claim 3 that supports at least a pair of rollers among the rollers.

9. A printer comprising:
a plurality of rollers that constitutes an ink-supply path extending from an ink-supply source to a recording medium; and
the printer-roller support structure according to claim 4 that supports at least a pair of rollers among the rollers.

10. A printer comprising:
a plurality of rollers that constitutes an ink-supply path extending from an ink-supply source to a recording medium; and
the printer-roller support structure according to claim 5 that supports at least a pair of rollers among the rollers.
